(19) United States
(12) Patent Application Publication
(10) Pub. No.: US 2013/0322073 A1
(43) Pub. Date: Dec. 5, 2013

(54) Light source assembly for portable lighting system

(71) Applicant: Magnum Power Products, LLC, Berlin, WI (US)

(72) Inventors: Keith Hamm, Oshkosh, WI (US); Dave McAllister, Berlin, WI (US)

(73) Assignee: Magnum Power Products, LLC, Berlin, WI (US)

(21) Appl. No.: 13/899,237

(22) Filed: May 21, 2013

Related U.S. Application Data
(60) Provisional application No. 61/649,590, filed on May 21, 2012.

(51) Int. Cl. F21V 21/06; F21V 7/00

(52) U.S. Cl. CPC F21V 21/06; F21V 7/0075
USPC 362/235; 362/249.1

(57) ABSTRACT

A light source assembly for a portable lighting system includes a tube assembly. The tube assembly includes at least two lamps, tube supports, and a tube mounted between the tube supports, the tube at least partially surrounding the area between the two lamps to form a light pipe. The tube assembly may be provided within a portable lighting system as part of the light source assembly, or as a convertible option or retrofit system for existing light source assemblies.

### PRIORITY CLAIM/CROSS-REFERENCE TO RELATED APPLICATIONS

This application claims priority from U.S. Provisional Patent Application Ser. No. 61/649,590, filed on May 21, 2012, which is incorporated herein by reference for all purposes.

### FIELD OF THE INVENTION

The present invention relates generally to the field of portable lighting systems. More particularly, the present invention relates to a light source assembly for a portable lighting system.

### BACKGROUND

Portable lighting systems are useful in a variety of situations. For example, portable lighting systems may be used to provide light for building and construction projects at nighttime or where the natural light of the environment is insufficient. Additional uses for portable lighting systems include providing lighting for search and rescue operations, disaster relief, oil and mining operations, sporting events, film recording, and other special events or projects where permanent or semi-permanent lighting systems are unavailable, or not practical.

Existing portable lighting systems generally include a light source that is made portable in some manner. The size of the lighting system and mechanism for making it portable are generally influenced by the size and power of the light source and the intended uses for the system. In many applications, it is desirable to mount the light source of the portable lighting system on a pole or a mast to elevate the light source to some degree. Thus, many commercial applications of portable lighting systems include a light source mounted on a mast, which is then mounted on some moveable platform, such as a stand, cart or trailer. Portable lighting systems may be powered by many known methods for providing power. In existing portable lighting systems, the power source may be provided in connection with the lighting system itself, such as the use of a generator. Additionally or alternatively, portable lighting systems may be powered by connecting to a power source, such as by plugging in to an electrical source. Light sources used in existing portable lighting systems can have many different configurations, varying in the number of bulbs or lamps used, intensity of light produced, placement or arrangement of lamps, as well as varying other well known characteristics of light sources.

Although portable lighting systems of various configurations are known and used, existing portable lighting systems have problems that include glare, light pollution, and a need for increasing light output to the ground. Glare can be problematic because it can cause a reduction in sight capabilities for people in the vicinity of a portable lighting system; glare can also be irritating and can cause fatigue among individuals if experienced over extended periods of time. Light pollution refers to multiple problems caused by unnecessary, inefficient, and unappealing artificial light. Problems caused by light pollution include, but are not limited to, decreased night visibility, energy waste, disruption of ecosystems, and adverse health effects. Additionally, it is desirable to increase light output from portable lighting systems downward, or to the ground, rather than upward because this is usually where it is needed most in applications for portable lighting systems. Increasing downward lighting from portable lighting systems also helps address the problems of inefficiency and light pollution.

Light quality in portable lighting systems can be improved in many applications with the use of a light tube or light pipe, provided in a tube assembly, where light is distributed over the length of the tube. A tube assembly may be provided as the light source for a portable lighting system, or a tube assembly may be provided in addition to other light sources in a portable lighting system. A tube assembly may also be provided as an option in a convertible light source arrangement such that the light source of a particular portable lighting system could be modified easily to include or use a tube assembly. Alternatively, a tube assembly may be provided as a kit to retrofit or supplement prior art or existing portable lighting systems or light source assemblies.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### SUMMARY OF THE INVENTION

A light source assembly for a portable lighting system comprising a base, two lamps mounted to the base, each lamp capable of providing light and the two lamps generally facing each other, two tube supports, each tube support positioned substantially around one of the two lamps, and a tube mounted between the two tube supports, the tube at least partially surrounding the area between the two facing lamps to form a light pipe. The light source assembly may comprise more than two lamps, in which at least two of the lamps may be used conventionally but may also be converted to form a light pipe.

A portable lighting system comprising a platform, the platform mounted to a moveable implement, a mast, the mast mounted to the platform, a light source assembly comprising a base, the base mounted to the mast, two lamps mounted to the base, each lamp capable of providing light and the two lamps generally facing each other, two tube supports, each tube support positioned substantially around one of the two lamps, and a tube mounted between the two tube supports, the tube at least partially surrounding the area between the two facing lamps to form a light pipe.

A retro fit kit for a light source assembly having at least two lamps comprising two tube supports, the tube supports capable of being positioned substantially around each of the two lamps, and the two lamps capable of being turned to substantially face each other, mounting equipment for mounting the tube supports to the light source assembly, and a tube for mounting between the two tube supports, the tube capable of being mounted at least partially surrounding the area between the two facing lamps to form a light pipe.

### BRIEF DESCRIPTION OF THE DRAWINGS

FIG. 1 is a perspective view of a prior art portable lighting system, namely the MLT4200 Light Tower manufactured by Magnum Power Products, LLC.

FIG. 2 is a perspective view of the prior art portable lighting system of FIG. 1 where the mast is configured for storage or travel.

FIG. 3 is a perspective view of a portable lighting system with a light source assembly in accordance with the present invention.

FIG. 4 is a perspective view of the portable lighting system of FIG. 3, where the mast is configured for storage or travel.

FIG. 5 is a detail perspective view of the light source assembly of FIG. 3.

FIG. 6 is a perspective view of one of the lamps from the light source assembly of FIG. 3, where the lamp is mounted using a lamp bracket, tube support, and lamp bracket connection assembly.

FIG. 7 is a perspective view of the lamp shown in FIG. 5 with a tube bracket mounted to the lamp bracket and tube support.

FIG. 8 is a top view of the light source assembly of FIG. 3.

FIG. 9 is a bottom perspective view of the light source assembly of FIG. 3 showing the front-bottom of the light source assembly.

FIG. 10 is an exploded perspective view of the light source assembly of FIG. 3.

### DETAILED DESCRIPTION

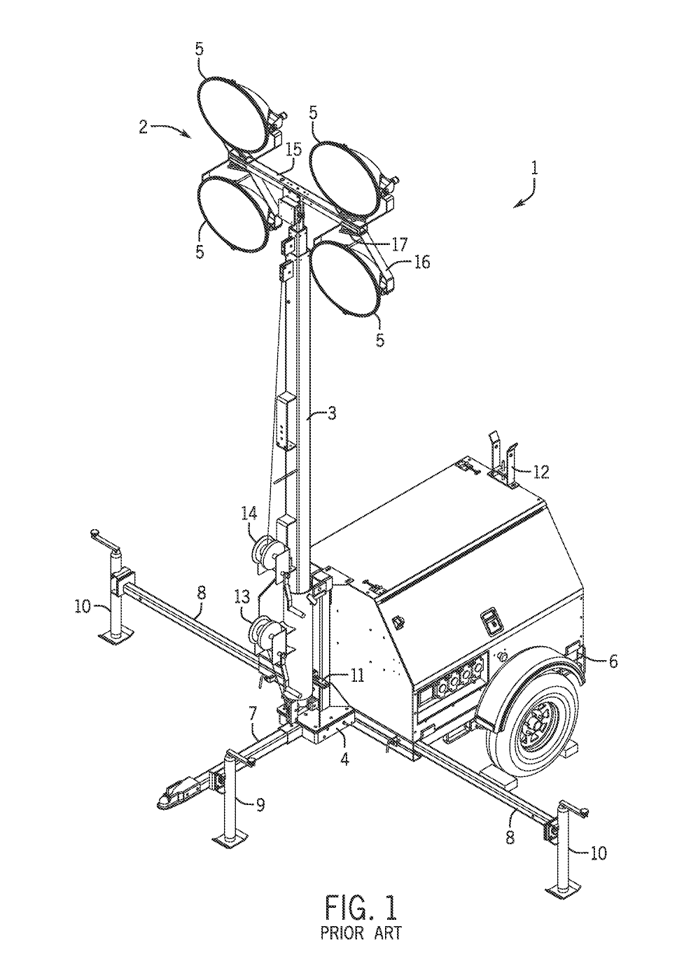

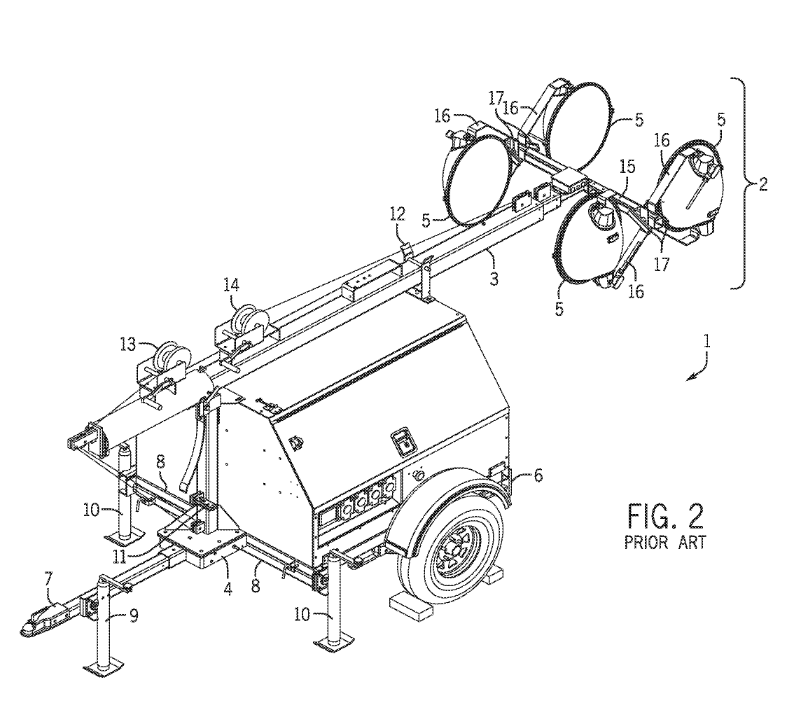

A portable lighting system 1 comprises a light source assembly 2, a mast 3, and a platform 4. FIGS. 1 and 2 show a prior art portable lighting system, specifically, the MLT4200 Light Tower manufactured by Magnum Power Products, LLC, having each of these elements. FIG. 1 shows the Magnum MLT4200 Light Tower configured for use when not attached to a vehicle, while FIG. 2 shows the system in which the mast 3 is configured for storage or for travel. In this prior art system, the light source assembly 2 of portable lighting system 1 in FIGS. 1 and 2 uses four lamps 5. Platform 4 is mounted to a trailer 6, having a tongue 7 for connecting to a hitch on a vehicle, and outriggers 8, for additional stability for the portable lighting system when in use for lighting applications when not attached to a vehicle. When the system is used for lighting when not attached to a vehicle, tongue 7 can be stabilized and positioned using tongue jack 9. Outriggers 8 can be extended outwardly and can be stabilized and positioned using outrigger jacks 10.

The mast 3 of the prior art portable lighting system in FIGS. 1 and 2 can be lowered for travel or storage, and raised for use in lighting applications. The mast 3 can be raised using a winch and pulley system. Mast 3 is secured for travel and storage with mast lock assembly 11 and mast cradle 12. To raise the mast 3, pins or locks from the mast lock assembly 11 and mast cradle 12 are removed. Lower mast winch 13 is used to raise the mast 3 to a vertical position. Upper mast winch 14 is used to telescope the mast 3 to the desired height. Mast 3 can also be rotated to position the light source assembly 2 in the desired position.

The light source assembly 2 of the prior art portable lighting system in FIGS. 1 and 2 includes four lamps 5 mounted on a base 15. Lamps 5 comprise a bulb in a socket in a reflector housing with a lens. Each lamp 5 is attached to base 15 in a trunnion-style mounting system using a lamp bracket 16 which is attached to base 15 with a lamp bracket connection assembly 17.

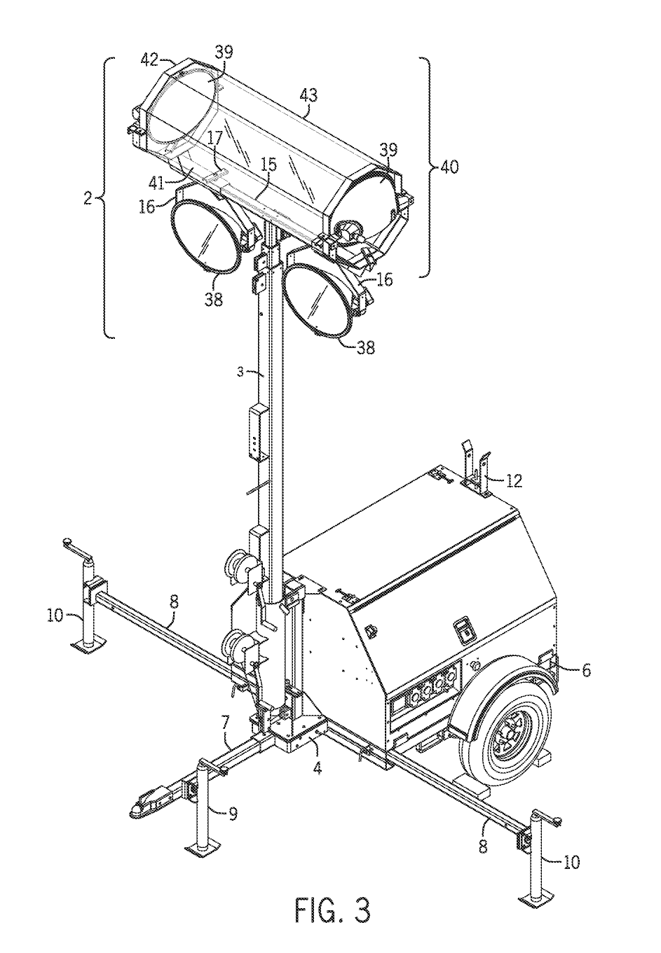

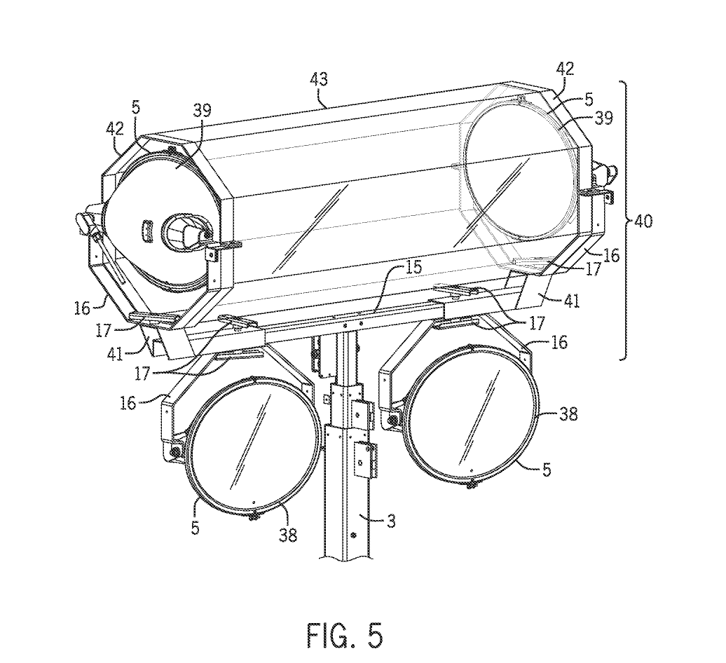

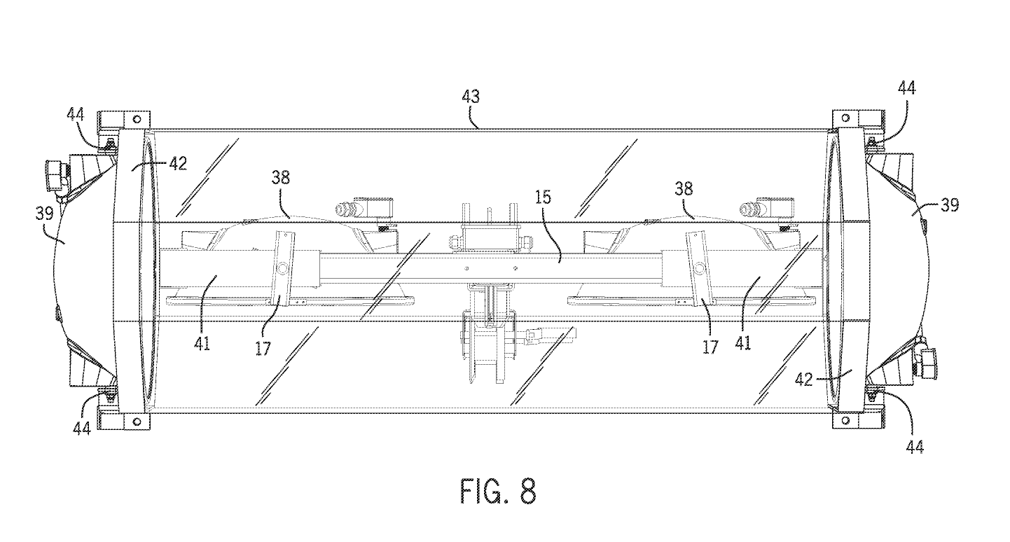

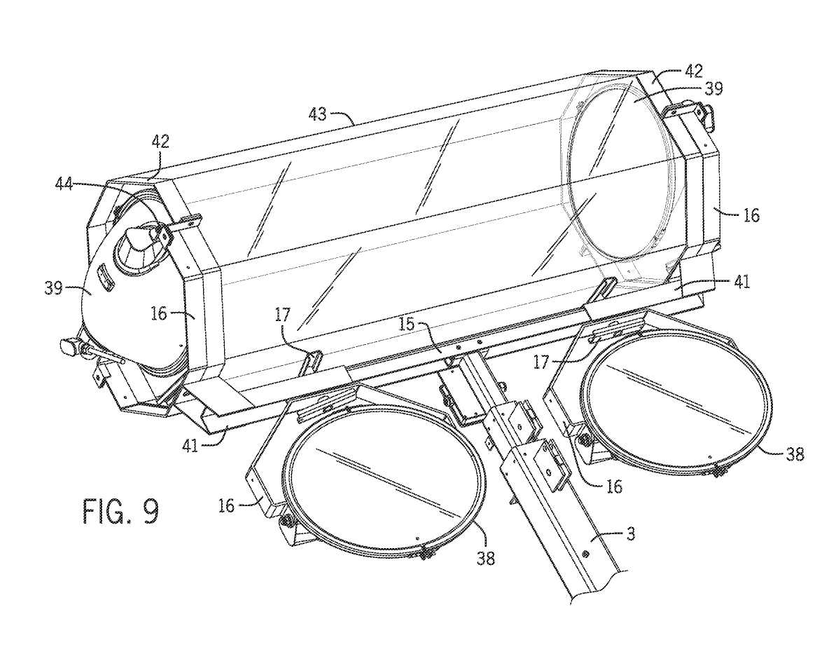

As shown in FIGS. 3-10, a light source assembly in accordance with the present invention is an improvement on the prior art portable lighting system shown in FIGS. 1 and 2 and is capable of employing a light pipe. The light source assembly 2 shown in FIGS. 3-5, and 8-10 includes a tube assembly 40. Light source assembly 2, includes four lamps: two lower lamps 38 and two upper lamps 39 that are mounted to a base 15, which in turn is mounted on the mast 3 of the portable lighting system. The two upper lamps 39 substantially face each other and are at least partially surrounded by a tube 43, creating a light tube or light pipe.

Although described herein in connection with the embodiment shown in FIGS. 3-10, it should be understood that any number of lamps or light tubes could be used, many different types of lamps could be used, and that lamps and the light tube or tubes could be arranged in a variety of configurations. For example, in a four-lamp system, the lamps may be in the same general plane as base 15, or in a diagonal plane, rather than in an upper-lower configuration as shown in FIGS. 3-10. Any number of lamps could be used to provide the light source for the light tube. In a four-lamp system of a different configuration, both sets, each pair, or all four lamps could be used in the light tube, so that the light source assembly may include two light tubes, or a larger light tube using all four lamps. Additionally, any number of lamps could be used, in both even and odd numbers. Although the tube assembly 40 shown in FIGS. 3-5, and 8-10 is shown using two lamps substantially facing each other, tube assembly 40 could use any number of lamps, even just one, or more than two. Lamps used in a tube assembly 40 also do not need to be facing each other. Lamps could comprise a bulb in a socket, or could comprise other light sources such as LEDs.

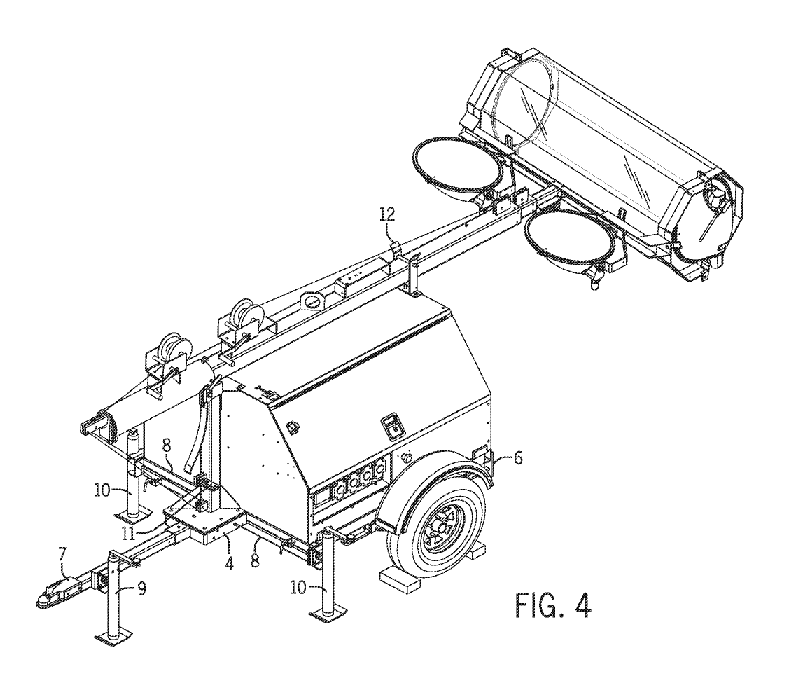

Similarly, there could be a wide range of variations in the other structures that comprise the light source assembly in accordance with the present invention. For example, mast 3 may be stationary, or may be adjustable in a variety of ways as explained above, or as would be readily apparent to one of ordinary skill in the art. FIGS. 3 and 4 show a portable lighting system, including a tube assembly 40 in accordance with the present invention, attached to a telescoping and collapsible mast 3, which is mounted to a platform 4 on a trailer 6. Many trailer styles are known in the art, but trailer 6, shown in FIGS. 3 and 4, has a tongue 7 for connecting to a hitch on a vehicle, and outriggers 8, tongue jack 9, and outrigger jacks 10 for additional stability for when the system is in use for lighting applications. FIG. 3 shows the system configured for use when not attached to a vehicle; FIG. 4 shows the system in which mast 3 is configured for storage of travel. It should be understood that mast 3 need not be mounted on a trailer but could be mounted to other implements, bases, or platforms as well. Base 15 may be mounted directly to mast 3 using bolts or other traditional connectors, or it may be mounted indirectly to mast 3 by being attached to another part or parts that are then mounted to mast 3. As well, although shown in the drawings, light source assembly 2 does not necessarily require a base 15 as shown in the drawings; for example if lamps 5 (38, 30) are mounted to another structure, or if mast 3 itself serves as a base 15.

Returning to the embodiment shown in FIGS. 3-5, and 8-10, lower lamps 38 are mounted to base 15 using lamp brackets 16, in the same fashion or similar fashion as the prior art system shown in FIGS. 1 and 2. Lamp brackets 16 for lower lamps 38 as shown in FIGS. 3-8 are mounted to base 15 using lamp bracket connection assemblies 17, which are shown as T-handle screw mounting systems. Lamp brackets 16 may be mounted to the base 15 in a number of different ways, and many different types of lamp bracket connection assemblies 17 may be used, including, but not limited to, other types of bolts, screws, or clamps, to sufficiently secure lamps to the base for use in lighting applications.

Also as shown in FIGS. 3-5, and 8-10, upper lamps 39 substantially face each other and are partially surrounded by tube 43 to create a light pipe. The use of a light pipe in a light source assembly 2 for use in a portable lighting system can be used to disperse light along the tube and reduce glare. A variety of types of materials may be used for tube 43, such as fabric, paper, plastic, composite materials, or a combination of materials such as fabric with plastic boning. The tube materials may also be treated to provide additional advantages, for example, the top portion of tube 43 may be reflective to help further reduce light pollution and increase light output to the ground.

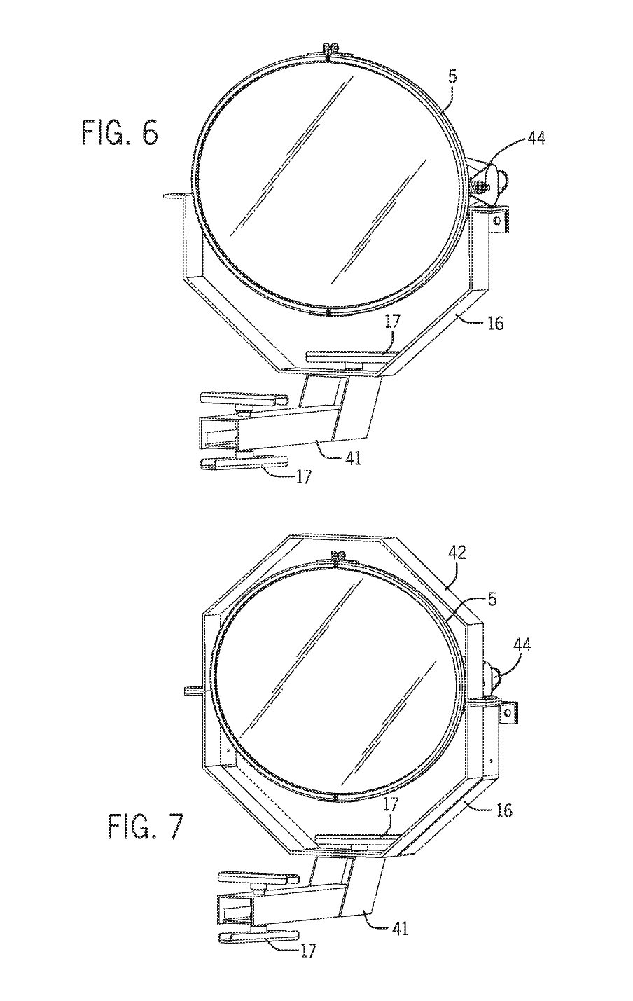

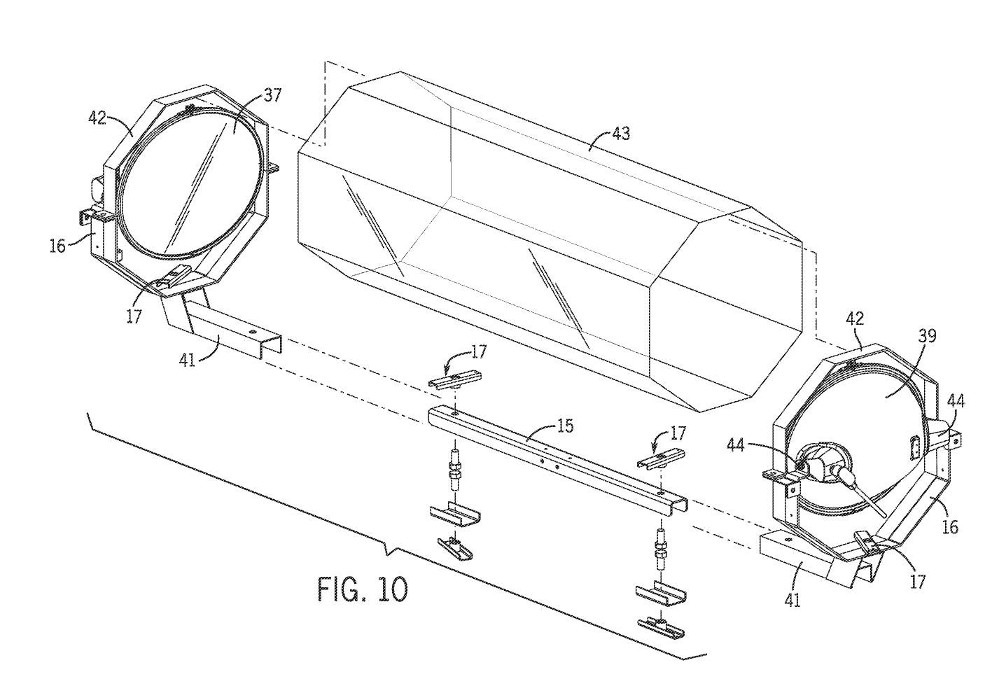

One way of providing the structure to support tube 43 is shown in FIGS. 3-10, but it should be understood that there are alternative structures that could be used for the same purpose. For example, instead of the structures pictured, the structure could be provided by a different type of bracket or suspension system, or frame, attached to a base or mast in a different manner. But as shown in the figures, upper lamps 39 are mounted to base 15 using a tube support 41 in addition to lamp bracket 16 and lamp bracket connection assembly 17. Upper lamp 39 is mounted to lamp bracket 16 using a trunnion-style mount 44. Lamp bracket 16 is mounted to tube support 41, which is mounted to the base 15. Tube support 41 helps to position upper lamps 39 for use in a tube assembly 40, and helps to provide the support for tube brackets 42. Tube bracket 42 is mounted to tube support 41 and/or lamp bracket 16, to provide the structure for tube 43. FIG. 6 shows a lamp 5 mounted to lamp bracket 16 and tube support 41, and FIG. 7 shows the same assembly with the addition of tube bracket 42. As shown in FIGS. 3-5, and 8-9, upper lamps 39 are mounted and positioned such that they substantially face each other, and are partially surrounded by a generally cylindrical tube 43. FIG. 10 is an exploded view of tube assembly 40 showing the interaction and positioning of these elements in the pictured embodiment.

As described above, a tube assembly 40 may be provided as a component of a portable lighting system, but it also may be provided as an alternative assembly configuration for a light source assembly. That is, light source assembly 2, can be a convertible assembly, such that at least one set of lamps can be converted from the traditional configuration shown in FIGS. 1 and 2 to be used in a tube assembly 40, and can be converted back, to provide the user with multiple configuration options. When provided as a convertible assembly, for example, upper lamps 39 may be configured as shown in FIGS. 1 and 2, for use without the tube assembly. In applications where the tube assembly 40 is desired, upper lamps 39 may be disconnected from base 15 and reconfigured using tube supports 41 and lamp bracket connection assemblies 17, such that the light source assembly 2 includes the tube assembly 40.

In another alternative embodiment, the tube assembly 40, including for example, tube supports 41, tube brackets 42, tube 43, and any necessary brackets or connection assemblies may be provided as a kit available for sale to retrofit or supplement prior art or existing portable lighting systems or light source assemblies.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A light source assembly for a portable lighting system comprising:
a base;
two lamps mounted to the base, each lamp capable of providing light and the two lamps generally facing each other;
two tube supports, each tube support positioned substantially around one of the two lamps; and
a tube mounted between the two tube supports, the tube at least partially surrounding the area between the two facing lamps to form a light pipe.

2. The light source assembly in claim 1 wherein each lamp is mounted to the base using lamp brackets to which tube supports are also mounted.

3. The light source assembly in claim 1, the tube comprising fabric.

4. The light source assembly in claim 1, the tube comprising reflective material to help direct light from the lamps.

5. The light source assembly in claim 1 comprising more than two lamps, in which at least two of the lamps are used to form a light pipe.

6. The light source assembly in claim 1 comprising more than two lamps, in which at least two of the lamps may be used conventionally but may also be converted to form a light pipe.

7. A portable lighting system comprising:
a platform, the platform mounted to a moveable implement;
a mast, the mast mounted to the platform;
a light source assembly comprising:
a base, the base mounted to the mast;
two lamps mounted to the base, each lamp capable of providing light and the two lamps generally facing each other;
two tube supports, each tube support positioned substantially around one of the two lamps; and
a tube mounted between the two tube supports, the tube at least partially surrounding the area between the two facing lamps to form a light pipe.

8. The portable lighting system in claim 7 wherein each lamp is mounted to the base using lamp brackets to which tube supports are also mounted.

9. The portable lighting system in claim 7, the tube comprising fabric.

10. The portable lighting system in claim 7, the tube comprising reflective material to help direct light from the lamps.

11. The portable lighting system in claim 7 comprising more than two lamps, in which at least two of the lamps are used to form a light pipe.

12. A retro fit kit for a light source assembly having at least two lamps comprising:
two tube supports, the tube supports capable of being positioned substantially around each of the two lamps, and the two lamps capable of being turned to substantially face each other;
mounting equipment for mounting the tube supports to the light source assembly; and
a tube for mounting between the two tube supports, the tube capable of being mounted at least partially surrounding the area between the two facing lamps to form a light pipe.

13. The retrofit kit in claim 12 wherein each tube support is mounted to a lamp bracket in the light source assembly.

14. The retrofit kit in claim 12, the tube comprising fabric.

15. The retrofit kit in claim 12, the tube comprising reflective material to help direct light from the lamps.

16. A light pipe assembly for a lighting system having at least two lamps, the light pipe assembly comprising:
a first tube support, the first tube support capable of being mounted substantially around one of the at least two lamps;
a second tube support, the second tube support capable of being mounted substantially around another one of the at least two lamps; and
a tube for mounting between the two tube supports, the tube at least partially surrounding the area between the two lamps to form a light pipe.
